(19) United States
(12) Patent Application Publication
(10) Pub. No.: US 2026/0203770 A1
(43) Pub. Date: Jul. 16, 2026

(54) COMPILATION OF DOCUMENTS FOR RESPONDING TO COMPLAINTS

(71) Applicant: Honeywell International Inc., Charlotte, NC (US)

(72) Inventors: Kartik Bollapalli, Bangalore (IN); Ankit Singh, Apex, NC (US)

(21) Appl. No.: 19/019,551

(22) Filed: Jan. 14, 2025

(51) Int. Cl. G06Q 30/016; G06F 16/93

(52) U.S. Cl. CPC G06Q 30/016; G06F 16/93

(57) ABSTRACT

Examples techniques to manage compilation of documents are described. A complaint document comprising a complaint in respect of a product is received. The complaint document is parsed to identify a type of the complaint. One or more legal documents databases is accessed to obtain outcome data pertaining to outcomes of complaints similar to the type of the complaint received in respect of the product. The outcome data is indicative of one or more documents referenced as evidence documents by a third-party in respect of the similar complaints. From a product lifecycle database, documents containing data generated at each of the stages of lifecycle of the product is retrieved. From amongst the retrieved documents, a set of documents to be furnished as evidence documents before the third-party to address the complaint is identified.

### BACKGROUND

Organizations across various industries engage in complex production processes to create a wide range of products, such as pharmaceutical products, automotive components, electronic devices, aerospace equipment, consumer goods, food and beverages, industrial machinery, and the like. These processes may involve multiple stages, such as research and development, prototype creation, testing, regulatory approval, production, quality control, distribution, post-market monitoring, and the like.

At each of these stages, various types of data may be generated and collected that may be important for ensuring product quality, safety, and efficiency. For example, during the research and development stage, data may include design specifications, experimental results, and initial product details. Prototype creation may generate performance data and refinement information. Trials may produce data related to product efficacy, durability, and safety. Production stage may involve data related to raw materials, production processes, equipment parameters, and batch records. Quality control may generate inspection results and compliance data. Distribution data may include logistics information and supply chain details. Post-market monitoring may collect data on product performance, customer feedback, and any other issues that may arise once a product is launched in a market for use.

For certain categories of products, storing and maintaining such data may be needed for compliance with statutory requirements. The volume and complexity of data generated throughout the lifecycle of the products may necessitate robust systems for data storage and management.

For the purpose of storing and managing the data generated throughout the lifecycle of a product, the organizations generally implement quality management systems (QMS). A QMS may be implemented to manage stages of the lifecycle of the product by implementing a stepwise workflow corresponding to each stage to monitor and control the process at the respective stages. Additionally, the QMS manages the data associated with each stage. The QMS stores data collected at various stages of the lifecycle of the product, including, but not limited to, research and development, testing, production, quality control, distribution, and post-market monitoring. Thus, the QMS may serve as centralized repositories for data pertaining to the product lifecycle, ensuring data integrity, traceability, and accessibility throughout the journey of the products from conception to market and beyond.

Storing data systematically at each stage of production and throughout the lifecycle of the product may serves multiple purposes. For example, the storing of the data may enable the organizations to maintain regulatory compliance by providing comprehensive documentation for audits and inspections. Also, the stored data may support continuous process improvement initiatives by allowing analysis of historical trends and identification of optimization opportunities. Moreover, this systematic data storage may prove invaluable when responding to various events that may require reference to the data pertaining to the lifecycle of the products.

Thus, having readily accessible, well-organized data pertaining to the lifecycle of the product may allow the organizations to quickly retrieve relevant information, conduct thorough analyses, and make informed decisions.

### SUMMARY

The details of some embodiments of the invention described in this specification are set forth in the accompanying drawings and the description below. Other features, aspects, and advantages of the invention will become apparent from the description, the drawings, and the claims.

The present subject matter relates to methods, systems, and non-transitory computer-readable media for document compilation.

In accordance with an embodiment of the present subject matter, the method for document compilation includes receiving a complaint document comprising a complaint in respect of a product. In an example, the complaint is received at a quality management system (QMS) that implements one or more workflows to manage stages of lifecycle of the product and store documents containing data generated at each of the stages of the lifecycle of the product. In an example, a response to the complaint requires an action to be taken to comply with statutory requirements associated with the complaint. The method further includes parsing the complaint document to identify a type of the complaint. The type of the complaint corresponds to at least one of a predefined categories of issues relating to the product. Furthermore, the method includes accessing one or more legal documents databases to obtain outcome data pertaining to outcomes of complaints similar to the type of the complaint received in respect of the product. The outcome data is indicative of one or more documents referenced to comply with statutory requirements in respect of the similar complaints. The method further includes, identifying and retrieving, based on the outcome data, a set of documents, from amongst the stored documents, that are required for complying with the statutory requirements associated with the complaint.

In accordance with another aspect of the present subject matter, the system for document compilation includes a processor configured to receive a complaint document comprising a complaint in respect of a product. The complaint requires one or more evidence documents to be produced before a third-party. The processor is further configured to parse the complaint document to identify a type of the complaint. The type of the complaint corresponds to at least one of a predefined categories of issues relating to the product. The processor is configured to access one or more legal documents databases to obtain outcome data pertaining to outcomes of complaints similar to the type of the complaint received in respect of the product. The outcome data is indicative of one or more documents referenced as evidence documents by the third-party in respect of the similar complaints. The processor is configured to retrieve, from a product lifecycle database, documents containing data generated at each of the stages of lifecycle of the product. The processor is further configured to identify, from amongst the retrieved documents, a set of documents to be furnished as evidence documents before the third-party to address the complaint.

In accordance with an embodiment of the present invention, the non-transitory computer-readable medium contains instructions that enable a processing resource to receive a notification corresponding to a non-compliance of a product to a set of predefined parameters associated with the product. In an example, the instructions are executable to parse the notification using a Large Language Model (LLM) to identify a type of the non-compliance. The type of non-compliance is associated with at least one of predefined categories of issues relating to the product. The instructions are further executable to execute, using the LLM, a query on internet to identify one or more documents associated with addressing the type of non-compliance. Further, the instructions are executable to access one or more legal documents databases to obtain outcome data pertaining to outcomes of non-compliances similar to the type of the non-compliance communicated in respect of the product. The outcome data is indicative of one or more documents referenced to address the similar non-compliances. The instructions are executable to access a quality management system (QMS) that implements one or more workflows to manage stages of lifecycle of the product and stores documents containing data generated at each of the stages of the lifecycle of the product. The instructions are executable to identify and retrieve, based on the outcome data and the identified one or more documents from the internet query, a set of documents required for addressing the non-compliance from amongst the stored documents in the QMS. The instructions are executable to generate a response to the notification based on the set of documents.

As per the embodiments of the present subject matter, the present subject matter enables efficient identification and compilation of relevant documents in response to receiving a notification regarding non-compliance of a product with parameters associated with the product. The present subject matter allows for analysing the notification and determining the type of non-compliance, facilitating the retrieval of appropriate documents from various sources.

The present subject matter further enables searching one or more databases, such as legal databases and the internet, to gather a list of documents that may be used to address the issues of non-compliance. Based on this search, relevant documents are accessed from the QMS. Thus, present subject matter thus facilitates streamlined document compilation by identifying the relevant documents from multiple sources, including legal databases and internet searches, and accessing the same from the QMS, thereby expediting the overall non-compliance response process and reducing potential oversights in addressing the non-compliance issues.

Additional features and advantages are realized through the concepts of the present invention, including improved recall management, reduced delays, and enhanced communication efficiency. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques for document compilation, in accordance with an example implementation of the present subject matter.

FIG. 2 illustrates a system for document compilation, in accordance with an example implementation of the present subject matter.

FIG. 3 illustrates the system for document compilation, in accordance with another example implementation of the present subject matter.

FIG. 4 illustrates a signal flow in a process of document compilation, in accordance with an example implementation of the present subject matter.

FIG. 5 illustrates a method for document compilation, in accordance with an example implementation of the present subject matter.

FIGS. 6A and 6B illustrate a flow diagram of a process for creating an evidence dosser of documents relevant for addressing a complaint received in respect of a product, in accordance with an example implementation of the present subject matter.

FIG. 7 illustrates a flow diagram of a process for identifying a type of the complaint received in respect of the product, in accordance with an example implementation of the present subject matter.

FIG. 8 illustrates a flow diagram of a process for determining a relevance score of each document in a set of documents identified to be relevant for addressing the complaint received in respect of the product, in accordance with an example implementation of the present subject matter.

FIG. 9 illustrates a computing environment for document compilation, in accordance with an example implementation of the present subject matter.

In the figures, the left-most digits of a reference number identify the figure in which the reference number first appears. The same numbers are used throughout the drawings to reference like features and components.

### DETAILED DESCRIPTION

Products, such as pharmaceutical products, undergo a complex lifecycle from initial ideation through to end-user availability. This journey usually encompasses multiple stages, including research and development, preclinical testing, clinical trials, regulatory review and approval, manufacturing, distribution, marketing, and post-market surveillance. Throughout this lifecycle, manufacturers of the products are required to adhere to stringent quality control measures and regulatory requirements to ensure the safety and efficacy of their products for public use.

However, despite rigorous quality control measures, various scenarios may arise that may lead consumers of the products to file complaint against the manufacturers of the products. These situations may encompass a wide range of issues, including, but not limited to, adverse reactions (such as severe side effects or long-term health complications), product defects (like contamination or manufacturing errors), false marketing claims, inadequate warnings or labeling, injuries from recalled products, overpricing, off-label promotion, lack of efficacy, clinical trial issues, and supply chain problems. For example, the adverse reactions of a product may involve immediate allergic responses or unforeseen long-term health complications, while the product defects may stem from production errors, inadequate quality control, or fundamental flaws in formulation. False marketing may include overstating benefits or downplaying risks of the product, and failure to warn may involve omitting safety information from labels of the product. Recalls may be mismanaged or delayed, leading to injuries. Overpricing issues often arise in markets with limited competition, for example, for essential medications. Off-label promotion of products may involve marketing a product for unapproved conditions or patient populations. The lack of efficacy of the product may result from misrepresented clinical trial results or real-world performance not matching marketing claims. The clinical trial issues may involve inadequate informed consent or protocol violations. Supply chain problems may include issues with raw material sourcing, transportation, storage, or quality control failures at supplier facilities. Each of these scenarios

Each of these situations may lead to various types of complaint against the manufacturer of the product, including, but not limited to, personal injury lawsuits, class action lawsuits, product liability lawsuits, breach of warranty lawsuits, and fraud and misrepresentation lawsuits. Each type of the lawsuit presents unique challenges and requires different approaches in terms of evidence gathering and legal strategy.

When faced with a complaint, a conventional approach to respond to the complaint may include reviewing documents accompanying the complaint, conducting thorough internal investigations, and gathering relevant evidence, usually carried out by specialized legal counsel and subject matter experts. This process often requires coordination between multiple departments of the manufacturer of the product, such as legal, regulatory affairs, research and development, manufacturing, and quality control.

A critical aspect of this response process is the selection and compilation of relevant documents to support the defence to be made by the manufacturer of the product against the complaint. Depending on the nature of the complaint, the manufacturer may be required to invest significant time and resources to identify and extract necessary information from a quality management system (QMS) that stores data pertaining to each stage of lifecycle of products manufactured by the manufacturer. This task usually requires consultation with subject matter experts who possess in-depth knowledge of both the industry and the intricacies of legal proceedings in the relevant sector. These subject matter experts may include, but are not limited to, pharmacologists, toxicologists, regulatory specialists, and clinical researchers, each requiring one or more documents having data generated at different stage of the product lifecycle in preparing a response to the complaint. For example, in a case involving alleged adverse reactions, pharmacologists may be consulted to interpret clinical data, toxicologists to assess safety profile of the product, regulatory specialists to ensure compliance with all relevant regulations, and clinical researchers to provide insights into development and testing phases of the product. This is done to ensure that all relevant aspects of the lifecycle of the product involved in the complaint are thoroughly examined, and that appropriate evidence is compiled to support the defence to be made by the manufacturer in response to the complaint.

However, this conventional approach of handling lawsuit is inefficient and has several drawbacks. Firstly, the above-mentioned conventional approach is time-consuming. The process of identifying, collecting, and analysing relevant documents may take weeks or even months, depending on the complexity of the complaint and the volume of data involved. This extended timeline may be problematic given the time-sensitive nature of legal proceedings, where delays may negatively impact the defence strategy or lead to unfavourable court rulings.

Additionally, the need to engage multiple subject matter experts throughout the process may incurs substantial costs to the manufacturer, straining resources of the manufacturer. Moreover, coordinating the efforts of multiple subject matter experts may be challenging and may lead to inefficiencies in the document compilation process.

Also, the reliance on manual effort in document selection and compilation may introduce a risk of human error. Despite the expertise of those involved, due to the large volume of data and the complexity of the products, important documents may be overlooked or misinterpreted. Such oversights may have severe consequences in the legal proceedings, weakening the defence of the manufacturer or exposing the manufacturer to additional liability. For example, failing to produce a key document that may demonstrate due diligence on part of the manufacturer in addressing safety concerns pertaining to a product may significantly impact the outcome of a complaint.

Furthermore, the conventional approach may lack standardization across different complaints or even within same organization. This may lead to inconsistencies in how similar complaints are handled that may result in disparate outcomes for similar complaints. This lack of a systematic approach also makes it difficult to learn from outcomes of past complaints and apply those lessons to future complaints, hindering the ability of the manufacturer to improve its legal defence strategies over time.

According to example implementations of the present subject matter, techniques that enable identification and retrieval of documents that may be relevant for responding to complaints filed against a manufacturer of products, such as pharmaceutical products, are described. These techniques may help streamline the process of compiling documents that may serve as evidence in response to various types of complaints. The techniques of the present subject matter may reduce the time and resources required to gather pertinent information from vast repositories of pharmaceutical data, while enhancing the accuracy and comprehensiveness of the evidence compilation process.

In accordance with example embodiments of the present subject matter, a method for data compilation in a process of preparing a response to a complaint filed in respect of a product may include receiving, in a quality management system (QMS), a complaint document comprising a complaint in respect of the product. As explained previously, the QMS implements workflows to manage stages of lifecycle of the product and stores documents containing data generated at each stage of the lifecycle of the product. In an example, a response to the complaint may require an action to be taken to comply with statutory requirements associated with the complaint.

Further, the complaint document is parsed to identify a type of the complaint. In an example, the type of the complaint may correspond to at least one of a predefined categories of issues relating to the product. The predefined categories of issues may include adverse reactions, product defects, false marketing claims, inadequate warnings or labelling, injuries from recalled products, overpricing, off-label promotion, lack of efficacy, clinical trial issues, supply chain problems, in an example. In an example, this identification of the type of the complaint may include utilizing a large language model (LLM) to analyse the complaint document, extracting contextual information, and classify the complaint based on comparison with a dataset of complaint types. For example, if the complaint document contains phrases such as “unexpected side effects” or “severe allergic reaction,” the LLM may classify complaint under the “adverse reactions” category. Similarly, if the complaint document mentions “misleading advertising” or “exaggerated claims,” the complaint may be classified under “false marketing claims”.

Furthermore, one or more legal documents databases may be accessed to obtain outcome data pertaining to outcomes of complaints similar to the type of the complaint received in respect of the product. In an example, the outcome data is indicative of one or more documents referenced to comply with statutory requirements in respect of the similar complaints. In an example, accessing the one or more legal documents databases may include performing a semantic search. The semantic search may account for linguistic variations between data included in the complaint document and the outcome data to obtain the outcome data pertaining to the outcomes of the complaints similar to the complaint received in respect of the product. For example, if the complaint relates to an adverse reaction to a pharmaceutical product, the semantic search may identify previous cases involving similar defects in related drugs. The outcome data may indicate that in such cases, documents such as clinical trial reports, adverse event logs, and updated product labelling were required to comply with regulatory requirements.

Based on the outcome data, a set of documents required for complying with the statutory requirements associated with the complaint is identified and retrieved from the stored documents in the QMS. In an example, to enhance the accuracy and relevance of the compiled documents, the present subject matter may incorporate input from subject matter experts. This input may validate the relevance of the selected documents or suggest modifications.

Additionally, in some examples, the present subject matter may include executing a query using the LLM against internet data to identify commonly used documents for complying with statutory requirements associated with the complaint type. These identified documents may be incorporated into the set of compiled documents.

Accordingly, by automatically identifying relevant documents, the present subject matter achieves efficient document compilation without requiring extensive manual intervention. This solves the problem of conventional methods that rely solely on manual document selection or rigid, pre-defined document sets. Thus, by optimizing the document compilation process, the present subject matter enables avoiding issues such as incomplete or irrelevant documentation, thereby maintaining regulatory compliance, product quality assurance, and operational efficacy in responding to product complaints.

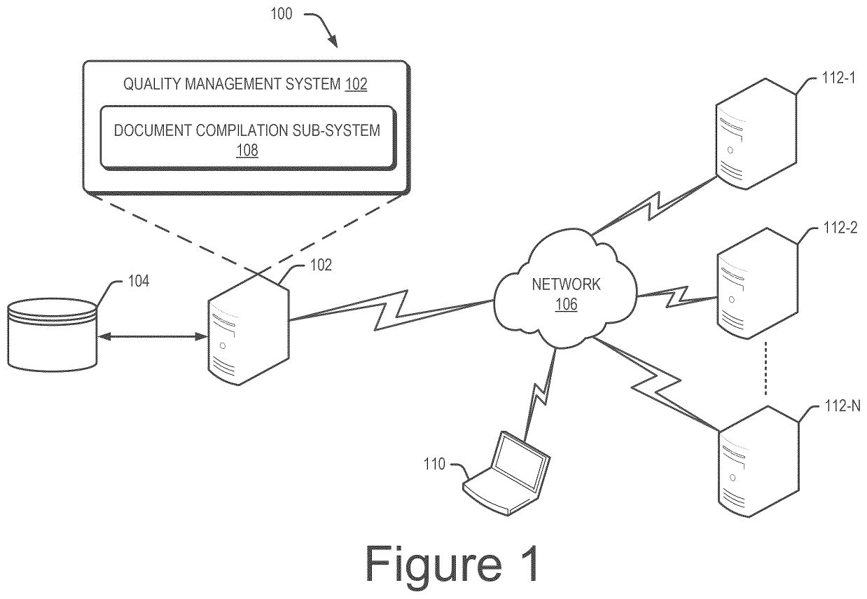

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 for implementing example techniques for compilation of documents that may be used to prepare a response to a complaint relating to a product, in accordance with an example implementation of the present subject matter.

In the pharmaceutical industry, complaints or complaints against manufacturers can arise from various issues, including but not limited to, safety concerns that pose risks to consumers, product performance issues that do not meet specifications, potential contamination in pharmaceutical products, use of substandard materials in the manufacturing process, or newly discovered adverse effects in drugs. In some instances, legal actions may be initiated in response to potential risks identified through post-market surveillance, even if no adverse events have been reported. Regulatory bodies may also mandate investigations or take legal action based on their own findings or reports from consumers, healthcare providers, or other stakeholders in the supply chain.

Responding to complaints often requires timely action and minimization of negative impact on the reputation and finances of the manufacturer of the product. As products are designed for a wide variety of uses, the nature and urgency of the complaints may vary considerably, catering to the respective safety and compliance concerns associated with each type of product. Document compilation systems, such as the one described in the present subject matter, are tools that may be used to streamline the process of gathering and organizing relevant documents that may be used to respond to the complaints.

In an example implementation of the present subject matter, the network environment 100 comprises a quality management system (QMS) 102. In an embodiment, the QMS 102 may be implemented and operated by a manufacturer of a product. The QMS 102 may implement one or more workflows to manage stages of lifecycle of the product. For example, the QMS 102 may implement workflows for research and development, clinical trials management, regulatory submission preparation, manufacturing process control, quality control and assurance, post-market surveillance, adverse event reporting, and product recall management. Each workflow may include specific steps, approvals, and documentation requirements to ensure compliance with regulatory standards and internal quality policies. The QMS 102 may also implement workflows for document control, change management, to maintain the integrity and traceability of all product-related information throughout its lifecycle.

In an embodiment, data generated by the QMS 102 at each of the stages of the lifecycle of the product may be stored in a product lifecycle database 104. The product lifecycle database 104 may contain a comprehensive record of the lifecycle of the product, including, but not limited to, research and development data, preclinical and clinical trial results data, manufacturing batch records data, quality control test results data, data on regulatory submission documents, post-market surveillance data, adverse event reports data, and the like. The product lifecycle database 104 may also store supply chain information, marketing materials, labeling changes, consignee data, and correspondence with regulatory authorities. The product lifecycle database 104 may be structured to maintain data integrity, version control, and audit trails, ensuring the traceability and authenticity of all stored information. Access to the product lifecycle database 104 may be controlled through role-based permissions to maintain data security and confidentiality.

In some implementations, the QMS 102 may be configured to handle changes in information related to lifecycle of the product, such as when new clinical data becomes available, manufacturing processes are modified, or regulatory requirements change. The QMS 102 may incorporate mechanisms for updating information pertaining to the lifecycle of the product. Various techniques may be used for the purposes of handling such updates. In an example, the information may be input to the QMS 102 by a user. The QMS 102 may provide a user interface, for example, a webpage or an electronic form that may be used by the user or the representatives to provide updates to the QMS 102 that may be reflected in the product lifecycle database 104. The product lifecycle database 104 may also be configured to allow for querying and retrieval of information based on various parameters, such as product type, development stage, date range, regulatory status, clinical trial phase, manufacturing batch, or specific quality attributes. The QMS 102 may also maintain a comprehensive audit trail of all updates to ensure traceability and compliance with regulatory requirements for data integrity and change management.

Though not shown in the example implementation depicted in FIG. 1, the product lifecycle database 104 may reside externally to the QMS 102, for instance in a database server communicatively coupled to the QMS 102. Thus, example implementations where the data stored in the product lifecycle database 104 is in an external database accessible by the QMS 102 are also possible. In an alternative embodiment, the product lifecycle database 104 may be more than one physical device, each holding data corresponding to one stage of the lifecycle of the product. For example, separate physical devices may store data related to research and development, clinical trials, manufacturing, quality control, and post-market surveillance, respectively.

The external product lifecycle database 104 may be accessed by the QMS 102 through a network 106. In an example, the network 106 may be a single network or a combination of multiple networks and may use a variety of different communication protocols. The network 106 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 106 includes various network entities, such as gateways, and routers; however, such details have been omitted for the sake of brevity of the present description.

In accordance with example implementations of the present subject matter, the QMS 102 includes a document compilation sub-system 108 (hereinafter “sub-system 108”). The sub-system 108 implements workflow for compilation of documents in response to the complaints filed against the manufacturer of the product, or any party associated with the manufacturer of the product.

Although the sub-system 108 is shown to be part of the QMS 102, in some implementations, the sub-system 108 may be implemented in a separate physical device that may operate in conjunction with the QMS 102 to optimize the process of identifying and retrieving a set of documents that may be relevant in responding to the complaint. Accordingly, example embodiments where the device implementing the functionality of sub-system 108 accesses the product lifecycle database 104 either directly or through the QMS 102 for example, through the network 106, are also possible.

In an embodiment, a complaint document comprising a complaint in respect of a product may be received at the sub-system 108. In an embodiment, the complaint document may be provided by a representative of the manufacturer via a user device 110 of the representative. Example of the user device 110 may include, but are not limited to, a desktop computer, a laptop, a tablet, a smartphone, or any other suitable computing device capable of connecting to the network 106 and communicating with the QMS 102. The QMS 102 may be communicatively coupled with the user device 110 over the network 106 to receive the complaint document. In some embodiments, the QMS 102 may be available locally on the user device 110, allowing for offline functionality of the QMS 102 and data synchronization when connectivity to the network 106 is established. The sub-system 108 of the QMS 102 may utilize various communication channels, such as email, SMS, or a dedicated portal to receive the complaint document pertaining to the product. The sub-system 108 may utilize various communication channels, such as email, SMS, or a dedicated portal to receive the complaint document pertaining to the product.

In an example, upon receipt of the complaint document, the sub-system 108 may initiate a workflow to process to identify and retrieve relevant documents that may be produced before a third-party, such as a regulatory authority or a court of law, in a process to respond to the complaint.

In doing so, in an embodiment, the sub-system 108 may parse the complaint document to identify a type of the complaint. In an example, the type of the complaint corresponds to at least one of a predefined categories of issues relating to the product. This parsing may include natural language processing techniques to extract key information and categorize the complaint.

In an embodiment, the sub-system 108 may then access one or more legal documents databases 112-1, 112-2, . . . , and 112-N to obtain outcome data pertaining to outcomes of complaints similar to the type of the complaint received in respect of the product or similar products in the past. In an example, the legal documents databases 112-1, 112-2, . . . , and 112-N may correspond to various sources of legal information, such as public court records, regulatory agency decisions, industry-specific legal repositories, and internal case law databases. In an example, the legal documents databases 112-1, 112-2, . . . , and 112-N may include, but are not limited to, federal and state court databases, FDA enforcement reports, EMA (European Medicines Agency) decision documents, pharmaceutical industry association legal archives, and historical legal case records of the manufacturer. In an example, the outcome data accessed from the legal documents databases 112-1, 112-2, . . . , and 112-N may be indicative of one or more documents referenced as evidence documents by the third-party in respect of the similar complaints. This helps in understanding the types of documents that have been used in responding to similar complaints.

Further, in an embodiment, the sub-system 108 may retrieve, from the product lifecycle database 104, documents containing data generated at each of the stages of lifecycle of the product. In an example, all relevant information pertaining to the product stored in the product lifecycle database 104 is considered. The retrieval process may involve querying the database using specific parameters related to the complaint, such as product name, batch numbers, date ranges, or specific quality attributes.

In accordance with example implementations of the present subject matter, the sub-system 108, based on the outcome data obtained from the legal documents databases, may identify, from amongst the retrieved documents, a set of documents to be furnished as evidence documents before the third-party to address the complaint. In an example, this identification process may involve analyzing the relevance and effectiveness of each document, for example, based on its content, metadata, and historical usage in resolving the complaints similar to the complaint filed in respect of the product, as indicated by the outcome data.

In an embodiment, once the set of documents is identified, the sub-system 108 may compile these documents into an evidence dossier. The evidence dossier may refer to a comprehensive collection of relevant documents, data, and information organized in a structured manner to be used to support the defense against the complaint. For example, the evidence dossier may include product specifications, quality control reports, clinical trial results, regulatory compliance documents, and relevant correspondence, all arranged in a logical order, for example, in a table of contents and cross-references for easy navigation.

Further, the sub-system 108 may route the evidence dossier through an approval workflow within the QMS 102 before submitting the same to the representative of the manufacturer. For example, the approval workflow may involve sequential review and sign-off, for example, by subject matter experts, such as a quality assurance manager, legal counsel, and senior management, each of whom may add comments or request additional information before the evidence dossier is finalized and released to the representative of the manufacturer for use in responding to the complaint.

Thus, the present subject matter optimizes the identification process of the relevant documents pertaining to a product for which a complaint is received. This is achieved by analyzing the complaint data to determine the type of complaint and relevant product lifecycle stages, ensuring targeted and effective document retrieval. The sub-system 108 of the QMS 102 allows for selecting the most relevant documents from the product lifecycle database 104 to be included in the response, thereby improving the accuracy and strength of the legal defense. This not only streamlines the document compilation process but also enhances the efficiency and effectiveness of the response management. By leveraging outcome data from similar cases stored in the legal documents databases 112-1, 112-2, . . . , and 112-N, the present subject matter ensures that the compiled documents are aligned with successful defense strategies, further optimizing the response to the complaints.

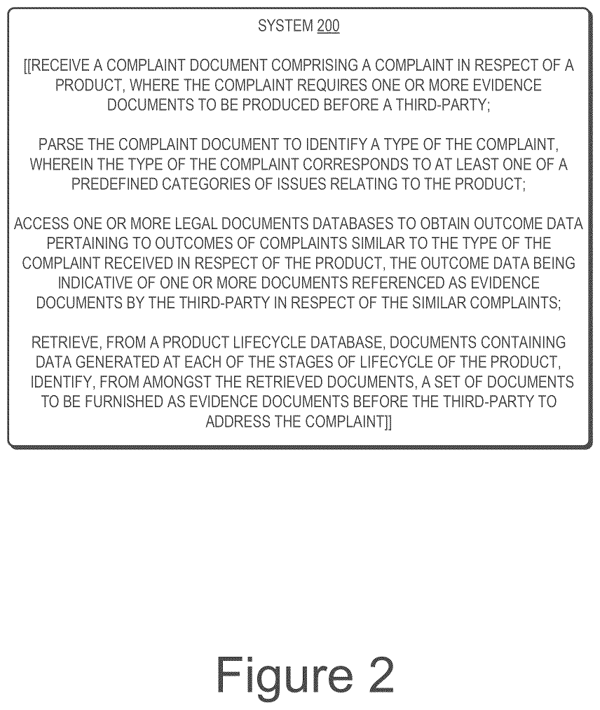

FIG. 2 illustrates a system 200 for document compilation to optimize the identification and compilation of relevant documents in response to the complaints, in accordance with an example implementation of the present subject matter. In an example implementation, the system 200 may be operable in conjunction with a QMS, such as the QMS 102 implemented by the manufacturer of the product to manage the various stages of lifecycle of the product and store data corresponding to the various stages of lifecycle of the product. As explained previously, in some example implementations, the system 200, as shown in FIG. 1, may be a part of the QMS 102, such that the QMS 102 is enabled to handle the compilation of the relevant documents that may be required to prepare a response to complaints filed in relation to the product.

Manufacturers of products, such as medical products may receive complaints due to various reasons such as product defects, regulatory non-compliance, or adverse effects. The system 200 may optimize the identification and compilation of the relevant documents from the product lifecycle database 104, leveraging historical legal outcomes to respond to such complaints.

In operation, the system 200 may receive a complaint document, for example, from the representative of the manufacturer, comprising a complaint in respect of a product. In an example, the complaint may require one or more evidence documents to be produced before a third-party, such as a regulatory agency, a court of law, or an arbitration panel.

Upon receiving the complaint document, the system 200 may parse the complaint document to identify the type of the complaint. In an example, the parsing process may involve natural language processing techniques to extract key information and categorize the complaint. The type of the complaint may correspond to at least one of predefined categories of issues relating to the product, such as safety concerns, efficacy issues, manufacturing defects, labeling discrepancies, or regulatory non-compliance.

In an embodiment, the system 200 may further access one or more legal documents databases, such as the legal documents databases 112-1, 112-2, . . . , and 112-N, to obtain the outcome data pertaining to the outcomes of complaints similar to the type of the complaint received in respect of the product. In an example, the outcome data may be indicative of documents referenced as evidence documents by the third-party in respect of the similar complaints.

In an embodiment, the system 200 may retrieve from the product lifecycle database 104, documents containing data generated at each of the stages of lifecycle of the product and based on the outcome data, identifies, from amongst the retrieved documents, a set of documents to be furnished as evidence documents before the third-party to address the complaint.

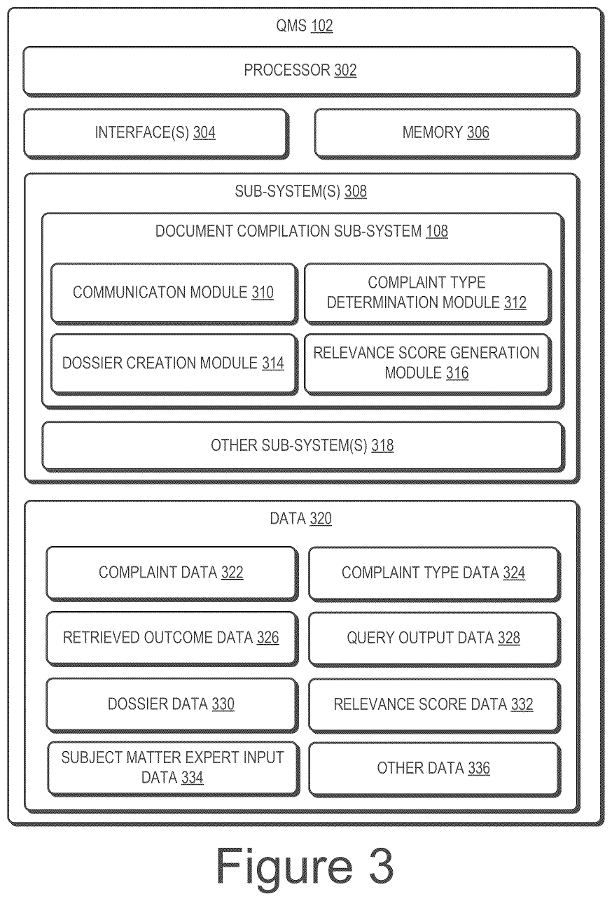

To elaborate on the functionality of the system 200 to optimize the process of the compilation of the relevant documents that may be used for responding to complaints received in respect of products, reference is made to FIG. 3.

FIG. 3 illustrates a QMS, such as the above-described QMS 102 for implementing techniques that optimize the process of identifying and retrieving a set of documents that may be relevant in responding to a complaint received in respect of a product or batches of products, in accordance with an example implementation of the present subject matter. Thus, in the example embodiment depicted in FIG. 3, the above-described system 200 for identifying and retrieving the set of relevant documents, as explained in respect of FIG. 2, is incorporated within the QMS 102 as the document compilation sub-system 108.

In an example, the QMS 102 depicted in FIG. 3 may be any computing device. Examples of the QMS 102 may include but are not limited to servers, desktop computers, laptops, smartphones, personal digital assistants (PDAs), and tablets.

In an embodiment, the QMS 102 may include a processor 302. In an example, the processor 302 may be implemented as microprocessors, microcomputers, microcontrollers, digital signal processors, central processing units, state machines, logic circuitries, and/or any devices that manipulate signals based on operational instructions. The QMS 102 may also include interface(s) 304 coupled to the processor 302. The interface(s) 304 may include a variety of software and hardware interfaces that allow interaction of the QMS 102 with other communication and computing devices, such as network entities, web servers, external repositories, and peripheral devices The interface(s) 304 may also enable coupling of internal components, if any, of the QMS 102 with each other.

Further, the QMS 102 may include a memory 306 coupled to the processor 302. The memory 306 may include any computer-readable medium known in the art including, for example, volatile memory (e.g., RAM), and/or non-volatile memory (e.g., EPROM, flash memory, etc.). The memory 306 may also be an external memory unit, such as a flash drive, a compact disk drive, an external hard disk drive, or the like.

Furthermore, the QMS 102 may include sub-system(s) 308 and data 320. In an example, the sub-system(s) 308 may be implemented as a combination of hardware and programming, for example, programmable instructions to implement a variety of functionalities of the sub-system(s) 308. In examples described herein, such combinations of hardware and programming may be implemented in several different ways. For example, the programming for the sub-system(s) 308 may be executable instructions. Such instructions in turn may be stored on a non-transitory machine-readable storage medium which may be coupled either directly with the QMS 102 or indirectly (for example, through networked means).

In an example, the sub-system(s) 308 may include a processing resource, for example, either a single processor or a combination of multiple processors, to execute such instructions. In the present examples, the processor-readable storage medium may store instructions that, when executed by the processing resource, implement the functionalities of the sub-system(s) 308. In another example, the sub-system(s) 308 may utilize the processor 302 of the QMS 102 to implement functionalities of the sub-system(s) 308. In other examples, the sub-system(s) 308 may be implemented as electronic circuitry.

The sub-system(s) 308 may include the document compilation system 108, referred to as the sub-system 108 in the present exemplary embodiments, and other sub-system(s) 318. The other subsystem(s) 318 may further implement functionalities that supplement applications or functions performed by the QMS 102 or any of the sub-system(s) 308 of the QMS 102. For example, other subsystem(s) 318 of the QMS 102 may include a product recall decision sub-system (not illustrated) and a product recall execution sub-system (not illustrated) that are configured to work in conjunction with the sub-system 108. The product recall decision sub-system may be used for determining products that are to be recalled based on various factors such as quality issues, safety concerns, or regulatory requirements. The product recall execution sub-system may be used for running workflows for executing the process of recall of the products identified for the recall. These sub-systems may complement the sub-system 108 by providing information and processes that may be relevant in responding to complaints, for example, those related to product recalls or quality issues.

The data 320, on the other hand, may include data that is either stored or generated as a result of functionalities implemented by the QMS 102 or any of the sub-system(s) 308 of the QMS 102. It may be further noted that information stored and available in the data 320 may be utilized by the sub-system(s) 308 for executing the workflows for identifying and retrieving the documents that may be used by the manufacturer of a product in a process to respond to a complaint received in respect of the product. In an example, the data 320 may comprise complaint data 322, complaint type data 324, retrieved outcome data 326, query output data 328, dossier data 330, relevance score data 332, subject matter expert (SME) input data 334, and other data 336. The data 320 serves, amongst other things, as a repository for storing data that may be fetched, processed, received, or generated by one or more of the sub-system(s) 308.

In an example embodiment of the present subject matter, a complaint document comprising a complaint in respect of a product may be received at the sub-system 108, for example, from a representative of the manufacturer of the product. For the purposes of the present description, any reference made to a product to be recalled may include a single product, a set or batch of a product, or multiple sets or batches of products. In an example, the complaint document may be a single document or a set of documents that collectively provide information about the complaint. The complaint document may include, but are not limited to, formal complaint filings, customer feedback forms, incident reports, quality control test results, or correspondence from regulatory authorities.

In an embodiment, the complaint may be initiated, for example, by an end user of the product, distributor of the product, a regulatory authority, a consumer protection agency, or a legal representative acting on behalf of an affected party. For example, in case of the product being a pharmaceutical product, the end user may be a patient who may have consumed the product, a healthcare provider who may have administered or prescribed the product, or a pharmacist who may have dispensed the product. In the case of the product being a medical device, the end user may be a patient using the device, a healthcare professional operating the device, or a healthcare facility where the device is installed.

In an embodiment, the complaint may be filed due to non-compliance of the product with a set of predefined parameters associated with the product. In an example, the predefined parameters associated with the product may include, but are not limited to, quality standards, safety requirements, efficacy claims, labeling accuracy, manufacturing processes, storage conditions, expiration dates, adverse effects, or any other regulatory or industry-specific guidelines applicable to the product. These predefined parameters may vary depending on the nature of the product, such as pharmaceuticals, medical devices, food products, or consumer goods, and the specific regulations governing their production and distribution in the relevant jurisdiction.

In an embodiment, the complaint document may be received from a third-party, such as the regulatory authority, a legal court, or the consumer protection agency. In an example, upon receiving the complaint document comprising the complaint filed in respect of the product, the representative of the manufacturer, for example, a legal counsel representing the manufacturer at an appropriate authority where the complaint is filed and that is to take the complaint for redressal, may access the sub-system 108 and enter the complaint received in respect of the product into the sub-system 108 to identify and retrieve relevant documents that may be used to prepare a response to the complaint.

In an embodiment, a communication module 310 of the sub-system 108 may provide an interface through which the representative of the manufacturer may enter information pertaining to the complaint included in the complaint document filed in respect of the product, for example, using the user device 110. In an example, this interface may be a secure web portal, a dedicated application, or an integrated component within the sub-system 108, allowing for standardized input of the information regarding the complaint. In an example, the information pertaining to the complaint may be input into the sub-system 108, for example, by manually entering the information regarding the complaint included in the complaint document through the interface. For example, the interface provided by the communication module 310 may include form fields for entering the information pertaining to the complaint, such as a name of the product, batch number, date of filing the complaint, complaint category, description of the complaint, and the like. In an alternative embodiment, the interface provided by the communication module 310 may allow for directly uploading the complaint document onto the sub-system 108. In an example, the information pertaining to the complaint received from the representative of the manufacturer or the complaint document uploaded by the representative may be stored in the data 320 as the complaint data 322.

In an embodiment, upon receiving the complaint data 322, a type of the complaint may be identified. In an example, to identify the type of the complaint, a complaint type determination module 312 of the sub-system 108 may parse the complaint document to identify the type of the complaint. In an example, the complaint type determination module 312 may use a large language model (LLM) to identify the type of the complaint. In doing so, the LLM may analyze the complaint document to extract contextual information. In an example, extracting the contextual information may include identifying a reason for filing the complaint. For example, issues that may have led to the filing of the complaint may be determined based on the description of the complaint. This may involve analyzing the specific details provided in the complaint document to understand the underlying problems or concerns that prompted a complainant to file the complaint. In an example, the LLM may be trained to recognize key phrases, symptoms, technical terms or industry jargon used, emotional tone or urgency of the complaint, involved third parties or complainants, and references to product specifications or quality standards mentioned in the complaint document that may indicate particular issues, such as product ineffectiveness, unexpected side effects, packaging problems, or quality inconsistencies, if the product is a pharmaceutical product.

Further, in an example, using the LLM, complaint type determination module 312 may compare the extracted contextual information with a dataset of complaint types. In an example, the dataset of complaint types may be created, for example, by analyzing historical complaint data, regulatory guidelines, and industry-specific quality standards. The dataset of complaint types may be structured as a collection of entries, where each entry may consist of a complaint type paired with its corresponding list of keywords and phrases commonly associated with that type of complaint. For example, an entry for “product defect” may include keywords such as “malfunction,” “failure,” “broken,” “not working,” and “faulty.” Similarly, an entry for “adverse reaction” may include terms like “side effect,” “allergic response,” “unexpected symptom,” and “health complication.” This dataset of complaint types may be continuously updated and refined based on new complaints, emerging issues, and feedback from quality management experts to ensure its relevance and accuracy in classifying incoming complaints. The LLM may then use this dataset of complaint types as a reference point to categorize new complaints by matching the extracted contextual information against these complaint types and their associated keywords.

Furthermore, based on this comparison, the LLM may classify the complaint into one or more of the predefined categories of issues. For example, if the complaint describes a product malfunction, the LLM may categorize the complaint as a “product defect” complaint. If the complaint mentions adverse health effects, the LLM may classify the complaint as a “safety issue” complaint. In cases where a complaint spans multiple issues, the LLM may assign the complaint to multiple relevant categories, such as both “packaging error” and “labeling issue” if the complaint describes incorrect information on packaging of the product. In an example, the classification process may involve the LLM matching the extracted contextual information, such as the identified reason for filing the complaint and the issues that led to the complaint, against the dataset of complaint types. This dataset of complaint types, created from historical complaint data, regulatory guidelines, and industry-specific quality standards, may serve as a comprehensive reference for accurate categorization. In an example, the LLM may output the classified predefined category of issue as the identified type of the complaint. In an example, information corresponding to the type of the complaint identified by the LLM may be stored in the data 320 as the complaint type data 324 for further processing.

In an embodiment, the communication module 310 may access one or more legal documents databases, such as the legal document databases 112-1, 112-2, . . . , and 112-N, for example, over the network 106, to obtain outcome data pertaining to outcomes of complaints similar to the type of the complaint received in respect of the product. As explained previously, the legal document databases 112-1, 112-2, . . . , and 112-N may be repositories that may store the outcomes of the complaints filed in respect of various types of products. In an example, these databases 112-1, 112-2, . . . , and 112-N may contain a wide range of legal documents, including but not limited to, court judgments, settlement agreements, regulatory decisions, and arbitration awards related to product complaints and litigation.

In an example, the communication module 310 may establish secure API connections with the legal document databases 112-1, 112-2, . . . , and 112-N to facilitate retrieval of the outcome data from the legal document databases 112-1, 112-2, . . . , and 112-N. In an example, these API connections may allow the communication module 310 to send structured queries to the legal document databases 112-1, 112-2, . . . , and 112-N and receive the outcome data as formatted responses. In an example, the APIs may support various authentication methods, such as OAuth or API keys, to ensure secure access to the sensitive legal information. It may be understood that other methods for establishing connections with the legal document databases 112-1, 112-2, . . . , and 112-N that are known in the art may also be used, such as direct database connections, file transfer protocols (FTP), web services, or custom integration solutions, for example, depending on the specific requirements and infrastructure of the legal document databases 112-1, 112-2, . . . , and 112-N.

In an embodiment, the communication module 310 may employ one or more search algorithms, such as Boolean search or machine learning-based relevance ranking algorithms, to query the legal document databases 112-1, 112-2, . . . , and 112-N, for example, using keywords, product category, identified complaint type, and other relevant parameters pertaining to the complaint extracted from the complaint document. This may help identify the outcome data that may indicate one or more documents that may have been referenced as evidence documents by the third-party in respect of the similar complaints. For example, if the current complaint involves an adverse reaction from a pharmaceutical product, the communication module 310 may search for previous complaints involving the same or similar pharmaceutical product, focusing on the types of evidence documents that were referred to in outcome of those complaints. This, for example, may include clinical trial reports, adverse event reports submitted to regulatory authorities, scientific literature on the side effects of the pharmaceutical product, expert testimonies, product safety data sheets, manufacturing quality control records, or pharmacovigilance reports.

In an example, the communication module 310 may analyze the frequency and relevance of these document types across similar complaints to determine which evidence documents are most commonly cited or have the greatest impact on outcomes of the similar complaints. This may help prioritize the types of documents to be included in the set of documents to be used for addressing the current complaint. Additionally, in an example, the communication module 310 may identify patterns in how these documents were used in previous complaints, such as specific sections of clinical trials that were scrutinized or particular types of expert testimonies that were deemed most credible.

In some embodiments, the communication module 310 may perform a semantic search to query the legal document databases 112-1, 112-2, . . . , and 112-N to obtain the outcome data. In an example, the semantic search may be performed to account for linguistic variations between the extracted information from the complaint document and the information available within the legal document databases 112-1, 112-2, . . . , and 112-N in obtaining the outcome data pertaining to the outcomes of the complaints similar to the type of the complaint received in respect of the product. For example, if the complaint document uses the term “unexpected side effect,” the semantic search may also identify those complaints as relevant similar complaints that use related terms such as “adverse reaction,” “unintended consequence,” or “drug-induced complication.” This ensures that the relevant similar complaints are not missed due to differences in terminology or phrasing. In an example, the semantic search may utilize natural language processing techniques, including word embeddings and contextual analysis, to understand the meaning and intent behind the language of the complaint and match it with semantically similar content in the legal document databases 112-1, 112-2, . . . , and 112-N, thereby improving the comprehensiveness and accuracy of the outcome data retrieved from the legal document databases 112-1, 112-2, . . . , and 112-N. In an example, the outcome data obtained from the legal document databases 112-1, 112-2, . . . , and 112-N may be stored in the data 320 as the retrieved outcome data 326.

In an embodiment, the communication module 310 may use the LLM to execute a query on the internet, for example, using the connection to the network 106, to identify one or more documents that are typically required to address complaints similar to the type of complaint received in respect of the product. For example, if the complaint pertains to an unexpected side effect of a pharmaceutical drug, the LLM may identify that documents pertaining to clinical trial results, current package insert of the pharmaceutical drug detailing known side effects of the pharmaceutical drug, recent pharmacovigilance reports, and the regulatory approval document may be useful in addressing the complaint received in respect of the product. In an example, data received from the internet corresponding to the documents that are typically required for addressing the complaint received in respect of the product may be stored in the data 320 as the query output data 328. In an example, the LLM to be used for identifying the type of the complaint may also be used for executing the query on the internet for identifying the documents that are typically required to address complaints similar to the type of complaint received in respect of the product. In an alternative embodiment, a separate LLM may be trained for use in executing the query on the internet.

In an embodiment, a dossier creation module 314 of the sub-system 108 may retrieve, from the product lifecycle database 104, documents containing data generated at each of the stages of the lifecycle of the product in respect of which the complaint has been received. In an example, to retrieve the document containing the data generated at each of the stage of the lifecycle of the product, the dossier creation module 314 may query the product lifecycle database 104 based on the type of the complaint. For example, if the complaint alleges that a pharmaceutical product causes liver toxicity, the dossier creation module 314 may prioritize retrieving documents related to liver function from various stages of the lifecycle of the pharmaceutical product. This may include, but is not limited to, liver toxicity studies from the pre-clinical stage, liver function test results from clinical trials, any liver-related warnings in the regulatory approval documents, liver-specific quality control parameters from the manufacturing stage, and post-marketing surveillance data on liver-related adverse events. By retrieving the documents based on the type of the complaint, the dossier creation module 314 may ensure that only the most relevant documents are retrieved instead of all the documents related to the product that are stored in the product lifecycle database 104.

In an example, the documents retrieved from the product lifecycle database 104 may include a plurality of versions of each document. In an example, each version may include updates to the document. For example, if a clinical trial protocol is retrieved, the clinical trial protocol may include an original protocol document (version 1.0), along with subsequent amended versions (e.g., versions 1.1, 1.2, 2.0) that reflect changes made during the course of the trial. Each version may contain updates such as modified inclusion/exclusion criteria, adjusted dosing regimens, or additional safety monitoring procedures. By retrieving all versions, it may be ensured that a comprehensive view of changes in the documents, allowing for a thorough understanding of any changes that may be relevant to addressing the complaint. In an alternative embodiment, retrieving the documents from the product lifecycle database 104 may include querying the product lifecycle database 104 for only a latest version of each document containing data generated at each of the stages of the lifecycle of the product. This is to ensure that the most up-to-date information regarding the product is retrieved from the product lifecycle database 104, reflecting the recent updates, amendments, or additional data that may be important in addressing the complaint effectively and accurately. For example, if a document pertaining to a clinical trial protocol is being retrieved, the dossier creation module 314 may specifically query for and obtain only the most recent version of the document (e.g., version 2.0). This latest version may incorporate all previous amendments and updates, such as modified inclusion/exclusion criteria, adjusted dosing regimens, or additional safety monitoring procedures that have been implemented over time. Retrieving the latest version of the documents also ensures that the most current and relevant information regarding the product is made available, streamlining the review process and reducing the potential for confusion or contradictions that may arise from examining multiple historical versions of the same document.

Further, in an embodiment, based on the retrieved outcome data 326 and the query output data 328, the dossier creation module 314 may identify, from amongst the retrieved documents pertaining to the product, a set of documents that may be furnished as the evidence documents before the third-party to address the complaint. For example, if the complaint alleges that a pharmaceutical product causes a specific side effect, and the retrieved outcome data 326 indicates that similar complaints were successfully addressed by providing detailed clinical trial results and post-marketing surveillance data, the dossier creation module 314 may prioritize these types of documents from the retrieved set. Additionally, if the query output data 328 suggests that regulatory bodies typically require manufacturing quality control records in such complaints, the dossier creation module 314 may also include relevant batch records and quality assurance documents in the set of evidence documents. This process ensures that the most relevant documents are identified for addressing the complaint.

In an embodiment, a relevance score generation module 316 may generate a relevance score for each document in the set of documents using the LLM. In an example, the LLM may analyze the content, metadata, and structure of each document in the set of documents, comparing it to the complaint type and documents referenced in the retrieved outcome data 326 and the query output data 328. The LLM may evaluate semantic similarity by considering shared keywords, product characteristics, regulatory contexts, and technical content, while also weighing the relevance of each document to different stages of the product lifecycle. In an example, the relevance score may be given in a range, for example, from 1 to 5, with 5 being the highest relevance score. For example, if a document titled “Liver Function Test Results from Phase III Clinical Trials” is referenced in the retrieved outcome data 326 as a relevant document for a liver toxicity complaint, documents included in the set of documents with similar content and characteristics such as “Recent Liver Safety Data from Post-Marketing Surveillance” may receive a score of 5, while documents with less related content like “Initial Compound Screening Results” may receive a lower relevance score of 1 or 2. In an example, the relevance score generation module 316 may rank each document in the set of documents based on the generated relevance score. In an example, data corresponding to the relevance score generated by the relevance score generation module 316 may be stored in the data as the relevance score data 332. In an example, the LLM to be used for identifying the type of the complaint may also be used for generating the relevance score for each document in the set of documents. In an alternative embodiment, a separate LLM may be trained for use in generating the relevance score for each document in the set of documents.

In an example, once the relevance score for each document in the set of documents is determined, the dossier creation module 314 may route the set of documents through an approval workflow within the sub-system 108. As explained previously, the approval workflow may include sequential review and sign-off, for example, by subject matter experts, such as a quality assurance manager, legal counsel, and senior management, each of whom may add comments or request additional information before the evidence dossier is finalized and released to the representative of the manufacturer for use in responding to the complaint.

In an embodiment, to receive an input from a subject matter expert in respect of the documents included in the set of documents, the communication module 310 may provide a user interface to allow the subject matter expert to review the documents and make changes in the set of documents, for example, using a user device, such as the user device 110. In an example, the subject matter expert may make changes to the set of documents based on roles defined for said subject matter expert. For example, a regulatory affairs expert may be authorized to change the order in which the documents are arranged in the set of documents to align with regulatory submission requirements. A clinical research expert may add or remove clinical trial documents from the set of documents based on their relevance to the specific complaint. A quality assurance expert may be permitted to modify the relevance score of the documents in the set of documents, while a legal expert may have the authority to add annotations or comments to specific documents in the set of documents regarding their statutory implications. In an example, input received from the subject matter experts may be stored in the data 320 as the SME input data 334. In an example, this stored input may be used for tracking changes, maintaining an audit trail for the changes made by the subject matter experts in the set of documents.

In an example, once the documents in the set of documents are reviewed and approved by the respective subject matter experts, the dossier creation module 314 may compile these documents into an evidence dossier. As explained previously, the evidence dossier may refer to a comprehensive collection of the relevant documents and/or data that may be used to provide a response to the complaint. The evidence dossier may include all relevant documents that may be necessary to address the specific allegations or concerns raised in the complaint.

Once the evidence dossier is reviewed and approved by the respective subject matter experts, the same may be made accessible to the representative of the manufacturer, for example, through the communication module 310. In an example, the communication module 310 may generate a notification to inform the representative of the manufacturer that the evidence dossier is ready for review. The representative may access the evidence dossier through a secure portal or user interface provided by the communication module 310 of the sub-system 108. This access may allow the representative to view the compiled documents, their relevance scores, and any annotations or comments added by the subject matter experts. The representative of the manufacturer may then use this comprehensive evidence dossier to prepare their response to the complaint. In some embodiments, the sub-system 108 may also provide options for the representative to request further clarifications or additional documents if needed, for example, in cases where the evidence dossier lacks information important for preparing the response to the complaint.

In an embodiment, the dossier creation module 314 may also generate a summary report of the identified set of documents included in the evidence dossier. This summary report, that may be created as a separate document within the evidence dossier, may list name, version, and associated relevance score for each document in the set of documents. For example, the summary report may contain entries such as “Liver Function Test Results from Phase III Clinical Trials, Version 2.1, Relevance Score: 5” and “Initial Compound Screening Results, Version 1.1, Relevance Score: 1”. By providing an overview of the documents, versions, and relative importance based on relevance scores, the summary report may enable efficient review and prioritization of the compiled information in the evidence dossier. In an example, data corresponding to the evidence dossier created by the dossier creation module 314 may be stored in the data 320 as the dossier data 330, for example, for subsequent access to the evidence dossier by the representative of the manufacturer.

Accordingly, the present subject matter allows for accessing the relevant documents from the product lifecycle database 104 and compiling them into a comprehensive evidence dossier that may be used to prepare response to a complaint. The present subject matter uses semantic search capabilities and large language models to identify and prioritize critical documents based on their relevance to the specific complaint. The present subject matter also facilitates a review process involving subject matter experts from various domains, who may refine and validate the compiled information. The resulting evidence dossier may provide manufacturers with a robust, well-organized set of documents to support their response of the complaint. This automated and intelligent approach reduces the time and effort required to gather and prepare evidence, while also improving the quality and completeness of the compiled information.

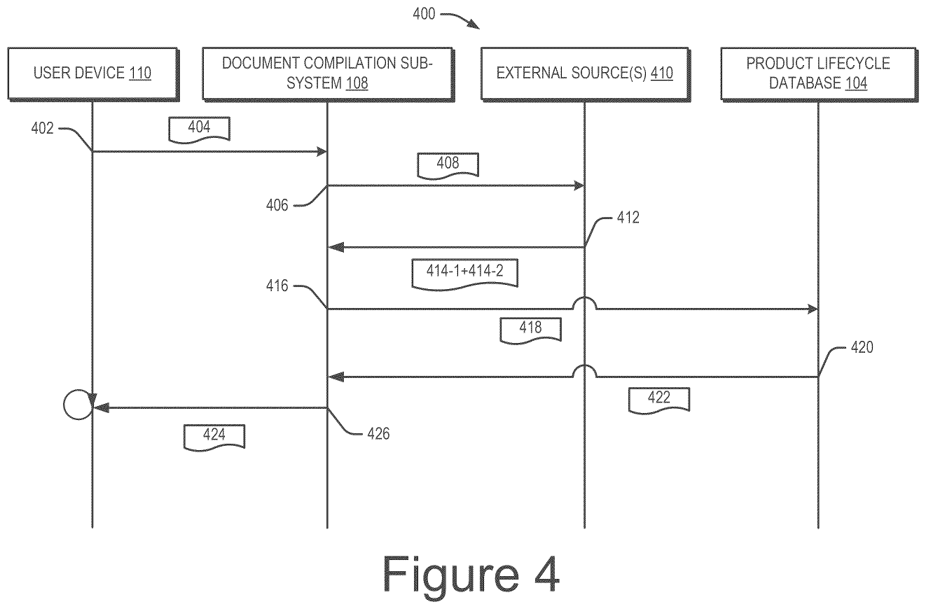

FIG. 4 illustrates a signal flow 400 in a process to compile documents that may be relevant for addressing a complaint received in respect of a product, according to an example implementation of the present subject matter.

As described in reference to FIGS. 1-3, a complaint may be received in respect of a product due to non-compliance of the product to a set of predefined parameters associated with the product. Once the complaint is received, a representative, such as a subject matter expert or a legal counsel, of the manufacturer, may need to take an action to address the complaint, for example, by comply with statutory requirements associated with the complaint. In an example, the action to be taken by the representative may include, but is not limited to, responding to the complaint before an authority who has issued the complaint. In an example, responding to the complaint may require documents that may be relevant for preparing a response to the complaint received in respect of the product. As explained previously, to identify and retrieve the documents that may be relevant for responding to the complaint received in respect of the product, the sub-system 108 may be used.

In an example implementation of the present subject matter, as indicated in step 402, a complaint document 404 received in respect of the complaint may be forwarded to the sub-system 108. As explained previously, upon receiving the complaint document 404, the sub-system 108 may parse the complaint document 404 to identify a type of the complaint. In an example, the type of the complaint corresponds to at least one of a predefined categories of issues relating to the product.

In an embodiment, as indicated in step 406, the sub-system may send an access request 408, for example, over the network 106, to access one or more external sources 410 to obtain outcome data pertaining to outcomes of complaints similar to the type of the complaints received in respect of the product. In an example, the outcome data may be indicative of one or more documents that may have been referenced to address the similar complaints. Through the external sources 410, the sub-system 108 may also identify documents that are typically required for addressing the statutory requirements associated with the type of the complaint received in respect of the product. In an example, the external sources 410 may include the legal documents databases 112-1, 112-2, . . . , and 112-N and the internet.

In an embodiment, as indicated in step 412, the outcome data 414-1 and data 414-2 corresponding to the documents identified from executing the query on the internet may be received at the sub-system 108. Based on the outcome data 414-1 and the data 414-2 corresponding to the documents identified from executing the query on the internet, the sub-system 108 may determine documents that may be relevant for addressing the complaint received in respect of the product.

In an embodiment, as indicated in step 416, based on the determination of the relevant documents, a retrieval request 418 may be sent by the sub-system 108 to the product lifecycle database 104 to identify and retrieve the documents that may be relevant for addressing the complaint received in respect of the product.

In an embodiment, as indicated in step 420, a set of documents 422 retrieved from the product lifecycle database 104 may be received at the sub-system 108. In an example, once the set of documents 422 that may be relevant for addressing the complaint are received at the sub-system 108, the sub-system 108 may compile this set of documents 422 into an evidence dossier 424. As explained previously, the evidence dossier 424 may refer to a comprehensive collection of the relevant documents and/or data that may be used to provide a response to the complaint. In an example, the evidence dossier 424 may include all relevant documents that may be necessary to address the specific allegations or concerns raised in the complaint.

In an embodiment, once the evidence dossier 424 is reviewed and approved by the respective subject matter experts, the same may be made accessible to the representative of the manufacturer, for example, on the user device 110 of the representative, as indicted in step 424.

In an embodiment, the dossier creation module 314 may also generate a summary report of the identified set of documents included in the evidence dossier. This summary report, that may be created as a separate document within the evidence dossier, may list name, version, and associated relevance score for each document in the set of documents. For example, the summary report may contain entries such as “Liver Function Test Results from Phase III Clinical Trials, Version 2.1, Relevance Score: 5” and “Initial Compound Screening Results, Version 1.1, Relevance Score: 1”. By providing an overview of the documents, versions, and relative importance based on relevance scores, the summary report may enable efficient review and prioritization of the compiled information in the evidence dossier. In an example, data corresponding to the evidence dossier created by the dossier creation module 314 may be stored in the data 320 as the dossier data 330, for example, for subsequent access to the evidence dossier by the representative of the manufacturer.

Accordingly, the present subject matter facilitates the retrieval of relevant documents from the product lifecycle database 104 and organizes them into a comprehensive evidence dossier 424. This evidence dossier 424 may serve as a resource for formulating a response to a complaint. The automated compilation of the relevant documents enhances time efficiency, allowing for access to the relevant documents that may otherwise require extensive manual effort. Furthermore, the present subject matter also contributes to cost efficiency by reducing the labor hours typically associated with manual document gathering.

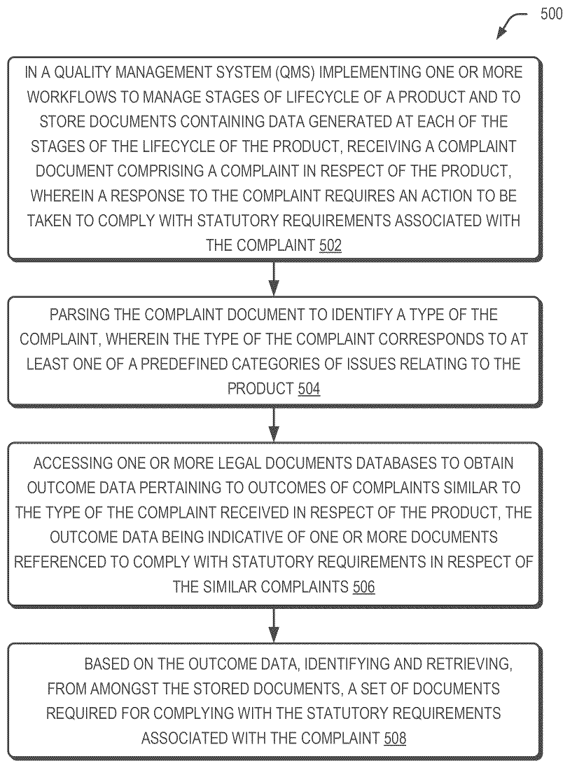

FIG. 5 illustrates a method 500 for document compilation, according to an example implementation of the present subject matter. Although the method 500 may be implemented in a variety of computer-based systems, for ease of explanation, the present description of the example method 500 for document compilation is provided in reference to the above-described document compilation sub-system 108.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof. The steps of the method 500 as well as other methods described herein may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, the method 500 may include receiving, for example at the QMS 102, a complaint document comprising a complaint in respect of a product. A response to the complaint requires an action to be taken to comply with statutory requirements associated with the complaint. As explained previously, the QMS 102 may implement one or more workflows to manage stages of lifecycle of the product and to store documents containing data generated at each of the stages of the lifecycle of the product which may be used in preparing an action in response to the complaint.

At block 504, the method 500 may include, parsing, for example, by the sub-system 108 of the QMS 102, the complaint document received in respect of the product to identify a type of the complaint. In an example, the type of the complaint may correspond to at least one of a predefined categories of issues relating to the product. As explained previously, the predefined categories of issues may relate to product quality, safety concerns, adverse reactions, packaging defects, labeling errors, efficacy issues, manufacturing inconsistencies, contamination, storage or handling problems, dosage inaccuracies, or regulatory compliance violations, and the like. In an example, the parsing may be performed using an LLM trained on relevant industry-specific data to accurately categorize and identify the type of the complaint.

At block 506, the method 500 may include accessing, for example, by the sub-system 108, one or more legal documents databases, such as the legal document databases 112-1, 112-2, . . . , and 112-N, to obtain outcome data pertaining to outcomes of complaints similar to the type of the complaint received in respect of the product. In an example, the outcome data may be indicative of one or more documents that may have been referenced, for example, by a third party, to comply with statutory requirements in respect of the similar complaints. As explained previously, the legal document databases 112-1, 112-2, . . . , and 112-N may include, but are not limited to, court case repositories, regulatory authority databases, scientific literature databases, industry standards databases, and compliance guideline repositories. These legal document databases 112-1, 112-2, . . . , and 112-N may contain historical records of the similar complaints, their outcomes, and the specific documents used to address regulatory requirements in each complaint.

At block 508, the method 500 may include identifying and retrieving, for example, by the sub-system 108, based on the outcome data, a set of documents required for complying with the statutory requirements associated with the complaint from amongst the stored documents in the QMS 102.

Thus, the example method 500 streamlines the process of identifying documents that may be relevant for preparing a response to a complaint filed in respect of a product. By leveraging the outcome data from legal document databases 112-1, 112-2, . . . , and 112-N, the sub-system 108 may enhance operational efficiency, reduces complexity, and ensures faster, more accurate responses to complaints. This facilitates a more robust and compliant handling of product-related issues, ultimately improving the effectiveness of the QMS 102.

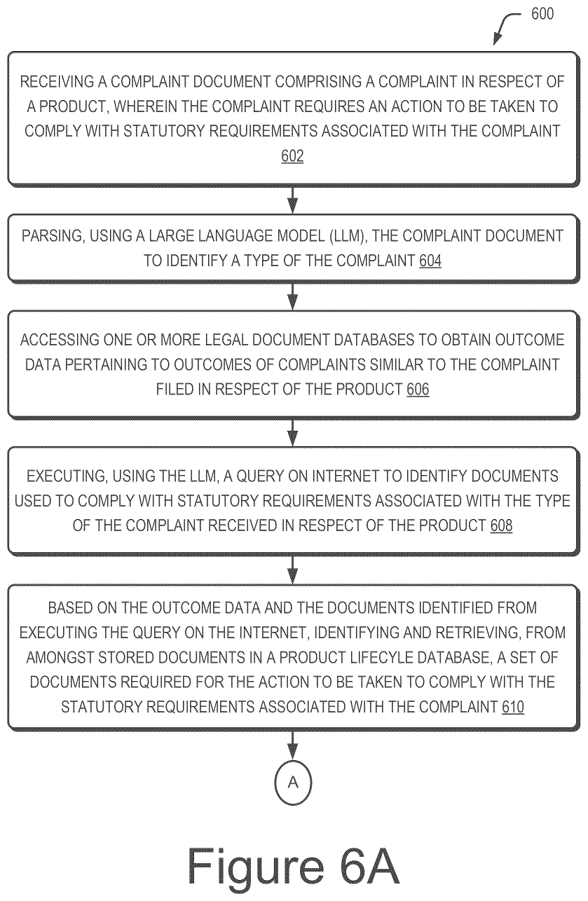

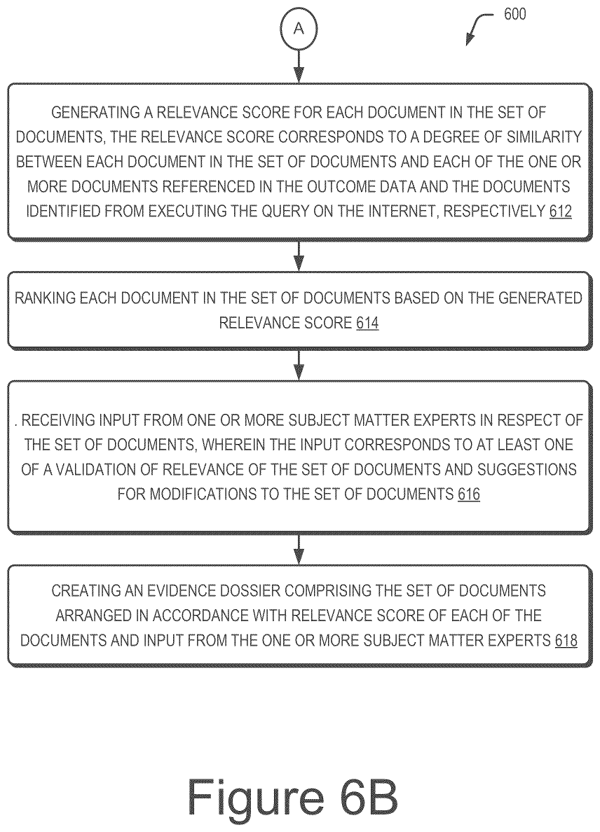

FIGS. 6A and 6B illustrate a flow diagram of a process 600 for creating an evidence dossier of one or more documents that may be relevant for addressing a complaint received in respect of a product, according to an example implementation of the present subject matter. The order in which the above-mentioned process 600 is described is not intended to be construed as a limitation, and some of the described process blocks may be combined in a different order to implement the process or an alternative process.

Further, the above-mentioned process 600 may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encoded computer-executable instructions, where the instructions perform some or all the steps of the above-mentioned process 600. In an example, the process 600 may be implemented by the sub-system 108, 200 of the QMS 102 of FIGS. 1, 2, and 3.

Referring to FIG. 6A, at block 602, the process 600 may include receiving, for example, at the sub-system 108 of the QMS 102, a complaint document. In an example, the complaint document may be received from a representative of the manufacturer of the product. As explained previously, the complaint may require an action to be taken to comply with statutory requirements associated with the complaint. In an example, the action to be taken in respect of the complaint may include, but is not limited to, gathering of essential information that may be used to comply with the statutory requirements associated with the complaint. This may include, but is not limited to, collecting detailed product information, batch records, quality control test results, relevant standard operating procedures, and the like. For example, if the complaint involves a potential adverse drug reaction, the manufacturer may need to gather patient safety data, clinical trial reports, and post-marketing surveillance data. Similarly, for a product quality complaint, the manufacturer may need to compile manufacturing records, supplier information, and quality assurance documentation.

At block 604, the process 600 may include parsing, for example, using a large language model (LLM) included with the sub-system 108, the complaint document to identify a type of the complaint.

At block 606, the process 600 may include accessing, for example, by the sub-system 108, one or more legal document databases, such as the legal document databases 112-1, 112-2, . . . and 112-N, to obtain outcome data pertaining to outcomes of complaints similar to the complaint filed in respect of the product.

At block 608, the process 600 may include executing, for example, using the LLM, a query on internet to identify documents that are typically used to comply with statutory requirements associated with the type of the complaint received in respect of the product. As explained previously, the “typical documents” in this context may refer to a range of standardized or commonly used documents that are generally required or recommended for addressing specific types of complaints. For example, referring to pharmaceutical industry, for a type of complaint, such as an adverse reaction from a medicine, the typical documents that may be used to address the complaint may include, but are not limited to, clinical trial safety reports, post-marketing surveillance data, adverse event reports, product safety summaries, pharmacovigilance protocols, risk management plans, patient information leaflets, product labeling information, batch manufacturing records, quality control test results, stability data, relevant standard operating procedures for handling adverse events, and the like.

At block 610, the process 600 may include, based on the outcome data and the documents identified from executing the query on the internet, identifying and retrieving, for example, by the sub-system 108, from amongst stored documents in a product lifecycle database, such as the product lifecycle database 104, a set of documents that may be required for the action to be taken to comply with the statutory requirements associated with the complaint.

Once the set of documents that may be relevant for complying with the statutory requirements associated with the complaint received in respect of the product is identified and retrieved from the product lifecycle database 104, the process 600 may proceed to block 612. Reference is made to FIG. 6B, wherein, at block 612, the process 600 may include generating, for example, using the LLM included with the sub-system 108, a relevance score for each document in the set of documents. As explained previously, the relevance score may correspond to a degree of similarity between each document in the set of documents and each of the one or more documents referenced in the outcome data and the documents identified from executing the query on the internet, respectively.

At block 614, the process 600 may include ranking each document in the set of documents based on the generated relevance score.

At block 616, the process 600 may include receiving input from one or more subject matter experts in respect of the set of documents. As explained previously, the input received from the one or more subject matter experts may correspond to validation of relevance of the set of documents and suggestions for modifications to the set of documents. For example, the subject matter experts may review the documents in the set of documents based on their relevance scores and provide input on accuracy of the relevance score given to each document in the set of documents. The subject matter experts may validate whether the documents with higher relevance scores are indeed the most pertinent to addressing the complaint. In some cases, a subject matter expert may identify a document with a lower relevance score that is actually important for specific complaint context, suggesting an adjustment to its relevance score. Conversely, the subject matter expert may flag documents with high relevance scores that may not be as applicable as the LLM initially determined.

At block 618, the process 600 may include creating an evidence dossier that includes the set of documents arranged in accordance with relevance score of each document in the set of documents and the input received from the one or more subject matter experts in respect of the set of documents. As explained previously, the evidence dossier may refer to a comprehensive compilation of relevant documents, data, and input from subject matter expert organized in a structured manner so as to enable the representative of the manufacturer to effectively address the complaint. In an example, the evidence dossier may include sections for different types of relevant documents, such as regulatory compliance documents, product quality data, safety information, and expert analyses. The evidence dossier may also incorporate annotations or summaries highlighting key points from each document, making it easier for reviewers, such as the representative of the manufacturer, to quickly grasp the most pertinent information.

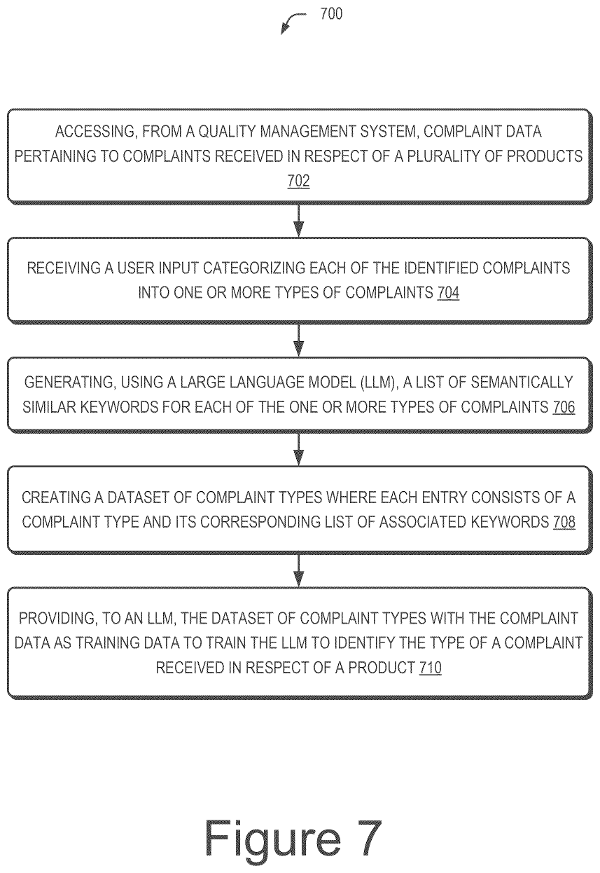

FIG. 7 illustrates a flow diagram of a process 700 for creating a dataset of complaint types to be used for determining type of a complaint received in respect of a product, according to an example implementation of the present subject matter. The order in which the above-mentioned process 700 is described is not intended to be construed as a limitation, and some of the described process blocks may be combined in a different order to implement the process or an alternative process.

Further, the above-mentioned process 700 may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encoded computer-executable instructions, where the instructions perform some or all the steps of the above-mentioned process 700. In an example, the process 700 may be implemented by the sub-system 108, 200 of the QMS 102 of FIGS. 1, 2, and 3.

Referring to FIG. 7, at block 702, the process 700 may include accessing, from a quality management system, such as the QMS 102, complaint data pertaining to complaints received in respect of a plurality of products. In an example, the complaint data may include historical records of complaints filed against various products, encompassing details such as the nature of the complaint, product information, date of complaint, resolution status, and any associated regulatory actions. This historical complaint data may span a significant time period to ensure a comprehensive representation of different types of complaints across various product lines and market conditions.

At block 704, the process 700 may include receiving, for example, by the sub-system 108, a user input categorizing each of the identified complaints into one or more types of complaints. In an example, the user input may be received, for example, from a subject matter expert in a field of quality management or regulatory compliance. The subject matter expert may review each complaint and assign it to one or more predefined categories of issues based on their professional judgment and industry standards. These categories of issues may include, but are not limited to, product defects, adverse reactions, packaging issues, labeling errors, efficacy concerns, and regulatory non-compliance. In some embodiments, a complaint may be assigned to multiple categories of issues if it spans several issues. In some examples, the subject matter expert may also have an option to create new categories if the subject matter expert encounters complaints that do not fit into existing categories.

At block 706, the process 700 may include generating, for example, using a large language model (LLM) included with the sub-system 108, a list of semantically similar keywords for each of the one or more types of complaints. For example, for a complaint type categorized as “product defect,” the LLM may generate a list of semantically similar keywords such as “malfunction,” “failure,” “flaw,” “imperfection,” “fault,” “breakdown,” and “deficiency.” Similarly, for a complaint type categorized as “adverse reaction,” the LLM may generate keywords like “side effect,” “allergic response,” “negative outcome,” “unintended consequence,” and “harmful reaction.” This expanded vocabulary for each complaint type enhances the ability of the sub-system 108 to accurately categorize future complaints by capturing a wider range of phrasings of the description of the complaint that may be included in the complaint document.

At block 708, the process 700 may include creating a dataset of complaint types where each entry consists of a complaint type and its corresponding list of associated keywords.

At block 710, the process 700 may include providing, to an LLM, the dataset of complaint types with the complaint data as training data to train the LLM to identify the type of a complaint received in respect of a product.

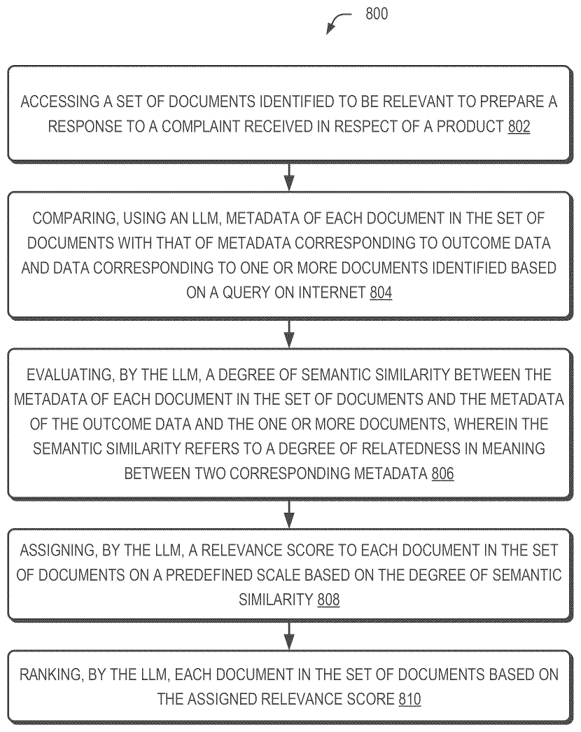

FIG. 8 illustrates a flow diagram of a process 800 for generating a relevance score for each documents included in a set of documents identified to be relevant for addressing a complaint received in respect of a product, according to an example implementation of the present subject matter. The order in which the above-mentioned process 800 is described is not intended to be construed as a limitation, and some of the described process blocks may be combined in a different order to implement the process or an alternative process.

Further, the above-mentioned process 800 may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encoded computer-executable instructions, where the instructions perform some or all the steps of the above-mentioned process 800. In an example, the process 800 may be implemented by the sub-system 108, 200 of the QMS 102 of FIGS. 1, 2, and 3.

Referring to FIG. 8, at block 802, the process 800 includes accessing a set of documents identified to be relevant to prepare a response to a complaint received in respect of a product. As explained previously, the complaint may be received due to non-compliance of the product to a set of predefined parameters associated with the product.

At block 804, the process 800 may include comparing, using a large language model (LLM), metadata of each document in the set of documents with that of metadata corresponding to outcome data and data corresponding to one or more documents identified based on a query on internet. In an example, the LLM to be used for identifying the type of the complaint may also be used for comparing the metadata. In an alternative embodiment, a separate LLM may be trained for use in comparing the metadata.

At block 806, the process 800 may include evaluating, for example, by the LLM, a degree of semantic similarity between the metadata of each document in the set of documents and the metadata of the outcome data and the one or more documents. In an example, the semantic similarity may refer to a degree of relatedness in meaning between two corresponding metadata. For example, the LLM may compare the metadata fields such as document titles, keywords, descriptions, and categories. The LLM may analyze the contextual meaning of these metadata elements to determine how closely they align with the metadata of the outcome data and the documents identified from the internet query. The LLM may consider factors such as synonyms, industry-specific terminology, and conceptual relationships to assess similarity. For instance, a document with metadata mentioning “adverse effects” may be considered semantically similar to outcome data referencing “negative reactions” or internet-sourced documents discussing “side effects.” This semantic analysis enables the sub-system 108 to identify relevant documents even when they use different but related terminology.

At block 808, the process 800 includes assigning a relevance score, by the LLM, to each document in the set of documents on a predefined scale based on the degree of semantic similarity. For example, the predefined scale may be one to five, where one represents the lowest relevance and five represents the highest relevance. A document with a high degree of semantic similarity to the outcome data and documents identified from the internet query may be assigned a score of five, indicating its strong relevance to the complaint. Conversely, a document with minimal semantic similarity may receive a score of one, suggesting limited relevance. In some examples, documents with moderate semantic similarity may be assigned scores of two, three, or four, depending on the specific degree of relevance determined by the LLM. This scoring system enables prioritization of the relevant document in the complaint response process. For example, documents with relevance score four or five may be considered essential for addressing the complaint, while those with relevance score as one or two may be deemed supplementary or unnecessary for the immediate response.

At block 810, the process 800 may include ranking, for example, by the LLM, each document in the set of documents based on the assigned relevance score.

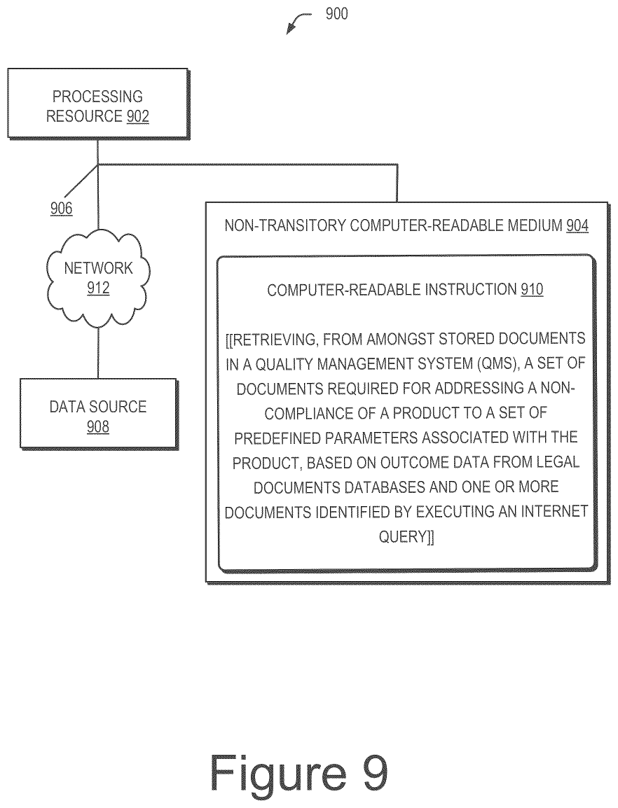

FIG. 9 illustrates a computing environment 900 for managing compilation of documents that may be relevant for preparing a response to a complaint filed in respect of a product, according to an example implementation of the present subject matter. The computing environment 900 includes a processing resource 902 communicatively coupled to a non-transitory computer-readable medium 904 through a communication link 906. In an example, the processing resource 902 may be the processor of the QMS 102, which fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 may access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. The data source(s) 908 may be used to store data corresponding to the product recall management process, for example.

In an example implementation, the non-transitory computer-readable medium 904 comprises executable instructions 910 for enabling the process of compilation of the relevant documents.

According to an example implementation of the present subject matter, the instructions 910 may cause the processing resource 902 to receive a notification corresponding to a non-compliance of a product to a set of predefined parameters associated with the product. In an example, the notification may be received in response to a representative of the manufacturer of the product requesting the document compilation sub-system 108 to compile a list of documents that may be used to respond to the non-compliance notified in respect of the product in the complaint.

In an example, this notification may include a complaint document contain a detailed description about the non-compliance, such as date of occurrence, description of the non-compliance, details of deviation from the predefined parameters, potential regulatory violations, and the contact information of complainant.

As explained previously, the predefined parameters associated with the product may include, but are not limited to, safety profiles detailing acceptable ranges for adverse reactions, quality control metrics for identifying product defects or contamination, marketing claim substantiation requirements, labelling and warning standards, recall thresholds and procedures, pricing guidelines and justifications, approved usage parameters, efficacy benchmarks and clinical endpoints, clinical trial protocols and safety standards, and supply chain quality assurance criteria. These predefined parameters may also encompass regulatory compliance standards for manufacturing processes, stability requirements, bioavailability targets, impurity limits, sterility assurance levels, and post-market surveillance protocols. Additionally, the predefined parameters may also include guidelines for off-label promotion restrictions, pharmacovigilance reporting thresholds, and criteria for assessing product liability risks.

In an embodiment, the instructions 910 may cause the processing resource 902 to parse the notification using a large language model (LLM) to identify a type of the non-compliance notified in respect of the product. In an example, the type of non-compliance may be associated with at least one of predefined categories of issues relating to the product. As explained previously, the predefined categories of issues include, but are not limited to, adverse reactions, product defects, false marketing, failure to warn, recalls, overpricing, off-label promotion, lack of efficacy, clinical trial issues, supply chain issues, and the like. For example, if the complaint document indicates a higher than expected rate of adverse reactions, the LLM may classify this as a non-compliance related to safety standards.

As explained previously, to identify the type of the non-compliance, the LLM may analyse the complaint document included with the notification to extract contextual information regarding the complaint. Further, the LLM may compare the extracted contextual information with a dataset of complaint types and classify the non-compliance into the at least one of the predefined categories of issues based on the comparison. Furthermore, the LLM may output the classified predefined category as the identified type of the non-compliance. For example, if the complaint document mentions unexpected side effects in patients taking a specific medication, the LLM may extract this information, compare it to known complaint types, and classify the non-compliance under “adverse reactions” category of issues. The LLM may then output “adverse reaction” as the identified type of non-compliance.

In an embodiment, the instructions 910 may cause the processing resource 902 to execute, using the LLM, a query on the internet to identify one or more documents associated with addressing the type of non-compliance. In an example, the one or more documents identified from executing the query on the internet may be documents that are typically required to address complaints similar to the type of complaint received in respect of the product. In an example, the LLM may identify certain documents on the internet as relevant to address the non-compliance based on the query results indicating typical documents commonly used for addressing similar non-compliance issues. For example, these document may include standard operating procedures (SOPs), batch records, product specifications, risk assessment reports, corrective and preventive action (CAPA) reports, audit trails, and quality control test results. The LLM may recognize patterns in the query results that suggest these documents are frequently referenced or required in resolving comparable non-compliance issues in an industry, for example, pharmaceutical industry.

In an embodiment, the instructions 910 may cause the processing resource 902 to access one or more legal documents databases, such as the legal document databases 112-1, 112-2, . . . , and 112-N to obtain outcome data pertaining to outcomes of non-compliances similar to the type of the non-compliance notified in respect of the product. In an example, the outcome data may be indicative of one or more documents referenced to address the similar non-compliances. As explained previously, the legal document databases 112-1, 112-2, . . . , and 112-N may include, but are not limited to, public court records, regulatory authority decisions, settlement agreements, and legal precedent databases, and may store information related to past legal cases, regulatory actions, and compliance resolutions. These legal document databases 112-1, 112-2, . . . , and 112-N may contain detailed records of the documents used, arguments presented, and outcomes achieved in cases involving similar non-compliance issues which may act as a reference for formulating strategies for addressing the non-compliance notified in respect of the product.

In an embodiment, the instructions 910 may cause the processing resource 902 to access the QMS 102, and based on the outcome data and the identified one or more documents from the internet query, identify and retrieve, from amongst the stored documents in the QMS 102, a set of documents that may be used for addressing the non-compliance notified in respect of the product. For example, if the non-compliance is related to an adverse reaction to a specific drug, and the outcome data from the legal document databases 112-1, 112-2, . . . , and 112-N may indicate that successful resolutions often involve presenting detailed clinical trial safety data and post-marketing surveillance reports, the processing resource 902 may identify and retrieve from the QMS 102 documents such as the clinical trial safety reports of the product, post-marketing adverse event summaries, batch manufacturing records for the affected lots, and relevant standard operating procedures for adverse event handling. Additionally, if the internet query identified regulatory guidelines on adverse event reporting as a relevant document, the processing resource 902 may also retrieve the internal policies and procedures that align with these guidelines from the QMS 102.

In an embodiment, the instructions 910 may cause the processing resource 902 to generate a relevance score for each document in the set of documents. In an example, the relevance score may correspond to a degree of similarity between each document in the set of documents and each of the one or more documents referenced in the outcome data and the identified one or more documents from the internet query. The processing resource 902 may rank each document in the set of documents based on the generated relevance score. In an example, the processing resource 902 may create an evidence dossier including the set of documents in an order of the relevance score and may transmit the evidence dossier to the representative of the manufacturer for preparing a response to the notification based on the set of documents.

In an embodiment, the instructions 910 may cause the processing resource 902 to generate a summary report of the identified set of documents that may be included in the evidence dossier separately. In an example, the summary report may be indicative of at least one of a name, version, and relevance score associated with each document in the set of documents.

Thus, the present subject matter streamlines the process of addressing the complaints received in respect of a product by automatically compiling relevant documents that may be used as evidence documents for addressing the complaints. This expedites the response preparation, reduces the risk of overlooking critical documents, and minimizes potential errors in addressing the non-compliance issues. By enhancing efficiency through automated document retrieval and relevance scoring, the present subject matter improves the accuracy and comprehensiveness of identification of the relevant documents. The evidence dossier that includes the set of relevant documents, prioritized based on relevance scores, allows representatives of the manufacturer to quickly access the most pertinent information, thereby mitigating the risk of inadequate responses and decreasing the likelihood of overlooked critical evidence in non-compliance management.

Although implementations of the document compilation techniques of the present subject matter have been described in language specific to structural features and/or methods, it is to be understood that the appended claims are not necessarily limited to the specific features or methods described. Rather, the specific features and methods are disclosed as example implementations of the techniques of document compilation.

1. A method for document compilation, comprising:
in a quality management system (QMS) implementing one or more workflows to manage stages of lifecycle of a product and to store documents containing data generated at each of the stages of the lifecycle of the product, receiving a complaint document comprising a complaint in respect of the product, wherein a response to the complaint requires an action to be taken to comply with statutory requirements associated with the complaint,
parsing the complaint document to identify a type of the complaint, wherein the type of the complaint corresponds to at least one of a predefined categories of issues relating to the product;
accessing one or more legal documents databases to obtain outcome data pertaining to outcomes of complaints similar to the type of the complaint received in respect of the product, the outcome data being indicative of one or more documents referenced to comply with statutory requirements in respect of the similar complaints; and
based on the outcome data, identifying and retrieving, from amongst the stored documents, a set of documents required for complying with the statutory requirements associated with the complaint.

2. The method of claim 1, wherein identifying the type of the complaint comprises using a machine learning (ML) model, wherein the ML model is to:
analyze the complaint document to extract contextual information;
compare the extracted contextual information with a dataset of complaint types;
classify the complaint into the at least one of the predefined categories of issues based on the comparison; and
output the classified predefined category as the identified type of the complaint.

3. The method of claim 1, further comprising receiving input from one or more subject matter experts in respect of the set of documents, wherein the input corresponds to at least one of a validation of relevance of the set of documents and suggestions for modifications to the set of documents.

4. The method of claim 1, wherein accessing the one or more legal documents databases comprises performing a semantic search, wherein the semantic search accounts for linguistic variations to obtain the outcome data pertaining to the outcomes of the complaints similar to the complaint received in respect of the product.

5. The method of claim 2, further comprising:
executing, using the LLM, a query on internet to identify one or more documents used to comply with the statutory requirements associated with the type of the complaint received in respect of the product; and
incorporating the identified one or more documents into the set of documents.

6. The method of claim 1, further comprising:
generating a relevance score for each document in the set of documents, the relevance score corresponds to a degree of similarity between each document in the set of documents and each of the one or more documents referenced in the outcome data; and
ranking each document in the set of documents based on the generated relevance score.

7. The method of claim 1, wherein the set of documents comprises a plurality of versions of each document in the set of documents, each of the versions of a document comprising updates to the document.

8. The method of claims 6, further comprising:
generating a summary report of the identified set of documents, the summary report being indicative of at least one of a name, version, and relevance score associated with each document in the identified set of documents.

9. A system for document compilation, comprising:
a processor configured to:
receive a complaint document comprising a complaint in respect of a product, where the complaint requires one or more evidence documents to be produced before a third-party;
parse the complaint document to identify a type of the complaint, wherein the type of the complaint corresponds to at least one of a predefined categories of issues relating to the product;
access one or more legal documents databases to obtain outcome data pertaining to outcomes of complaints similar to the type of the complaint received in respect of the product, the outcome data being indicative of one or more documents referenced as evidence documents by the third-party in respect of the similar complaints;
retrieve, from a product lifecycle database, documents containing data generated at each of the stages of lifecycle of the product,
identify, from amongst the retrieved documents, a set of documents to be furnished as evidence documents before the third-party to address the complaint.

10. The system of claim 9, wherein to identify the type of the complaint, the processor is configured to:
analyze, using a Large Language Model (LLM), the complaint document to extract contextual information;
compare the extracted contextual information with a dataset of complaint types;
classify the complaint into the at least one of the predefined categories of issues based on the comparison; and
output the classified predefined category as the identified type of the complaint.

11. The system of claim 10, wherein the processor is configured to:
execute, using the LLM, a query on internet to identify one or more documents used to address complaints similar to type of the complaint received in respect of the product; and
incorporate the identified one or more documents into the set of documents.

12. The system of claim 9, wherein to access the one or more legal documents databases, the processor is configured to perform a semantic search, wherein the semantic search accounts for linguistic variations to obtain the outcome data pertaining to the outcomes of the complaints similar to the type of the complaint received in respect of the product.

13. The system of claim 9, wherein the processor is configured to:
generate a relevance score for each document in the set of documents, the relevance score corresponds to a degree of similarity between each document in the set of documents and each of the one or more documents referenced in the outcome data; and
rank each document in the set of documents based on the generated relevance score.

14. The system of claim 9, wherein retrieving from the product lifecycle database comprises querying the product lifecycle database for documents based on the type of the complaint.

15. The system of claim 14, wherein retrieving documents from the product lifecycle database comprises querying the product lifecycle database for latest version of each document in the set of documents.

16. The system of claim 1, wherein the processor is further configured to generate a summary report of the identified set of documents, the summary report being indicative of at least one of a name, version, and relevance score associated with each document in the identified set of documents.

17. A non-transitory computer-readable medium comprising instructions executable by a processing resource to:
receive a notification corresponding to a non-compliance of a product to a set of predefined parameters associated with the product, wherein the notification requires compilation of one or more documents to be used for addressing the non-compliance;
parse, using a Large Language Model (LLM), the notification to identify a type of the non-compliance, wherein the type of non-compliance is associated with at least one of predefined categories of issues relating to the product;
execute, using the LLM, a query on internet to identify one or more documents associated with addressing the type of non-compliance;
access one or more legal documents databases to obtain outcome data pertaining to outcomes of non-compliances similar to the type of the non-compliance notified in respect of the product, the outcome data being indicative of one or more documents referenced to address the similar non-compliances;
access a quality management system (QMS) that implements one or more workflows to manage stages of lifecycle of the product and stores documents containing data generated at each of the stages of the lifecycle of the product; and
based on the outcome data and the identified one or more documents from the internet query, identify and retrieve, from amongst the stored documents in the QMS, a set of documents required for addressing the non-compliance.

18. The non-transitory computer-readable medium of claim 17, wherein to identify the type of the complaint, the processing resource is to:
analyze, using the LLM, the notification to extract contextual information;
compare the extracted contextual information with a dataset of complaint types;
classify the non-compliance into the at least one of the predefined categories of issues based on the comparison; and
output the classified predefined category as the identified type of the non-compliance.

19. The non-transitory computer-readable medium of claim 17, further comprising instructions executable by the processing resource to:
generate a relevance score for each document in the set of documents, the relevance score corresponds to a degree of similarity between each document in the set of documents and each of the one or more documents referenced in the outcome data and the identified one or more documents from the internet query; and
rank each document in the set of documents based on the generated relevance score.

20. The non-transitory computer-readable medium of claim 17, further comprising instructions executable by the processing resource to generate a summary report of the identified set of documents, the summary report being indicative of at least one of a name, version, and relevance score associated with each document in the set of documents.
